(19) United States
(12) Patent Application Publication
(10) Pub. No.: US 2013/0169091 A1
(43) Pub. Date: Jul. 4, 2013

(54) HYDRODYNAMIC BEARING MODULE AND SPINDLE MOTOR HAVING THE SAME

(71) Applicant: Samsung Electro-Mechanics Co., Ltd., Suwon (KR)

(72) Inventor: Sang Yong Oh, Suwon (KR)

(73) Assignee: SAMSUNG ELECTRO-MECHANICS CO., LTD., Suwon (KR)

(21) Appl. No.: 13/728,894

(22) Filed: Dec. 27, 2012

(30) Foreign Application Priority Data
Dec. 29, 2011 (KR) 10-2011-0146078

(51) Int. Cl. H02K 7/08; F16C 32/06

(52) U.S. Cl. CPC H02K 7/08; F16C 32/06
USPC 310/90; 384/107

(57) ABSTRACT

Disclosed herein is a hydrodynamic bearing module including: a shaft having a flange part formed at a lower portion thereof; a sleeve rotatably supporting the shaft; a cover coupled to a lower end portion of the sleeve and supporting the shaft; a radial bearing formed between the shaft and the sleeve in a radial direction of the shaft; and an upper thrust bearing formed between the flange part and the sleeve and a lower thrust bearing formed between the flange part and the cover, in an axial direction of the shaft.

### CROSS REFERENCE TO RELATED ED APPLICATION

This application claims the benefit of Korean Patent Application No. 10-2011-0146078, filed on Dec. 29, 2011, entitled “Hydrodynamic Bearing Module and Spindle Motor Having the Same”, which is hereby incorporated by reference in its entirety into this application.

### BACKGROUND OF THE INVENTION

1. Technical Field

The present invention relates to a hydrodynamic bearing module and a spindle motor having the same.

2. Description of the Related Art

Generally, in a spindle motor used as a driving device of a recording disk such as a hard disk, or the like, a hydrodynamic bearing using dynamic pressure generated by a lubricating fluid such as oil, or the like, stored between a rotor part and a stator part at the time of rotation of the motor has been widely used.

More specifically, since the spindle motor including the hydrodynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk device, a magnetic disk device, or the like.

Performance of a hard disk drive (HDD) motor using the hydrodynamic bearing described above depends on a dynamic pressure design. Therefore, a more efficient dynamic pressure design has been demanded.

### SUMMARY OF THE INVENTION

The present invention has been made in an effort to provide a hydrodynamic bearing module including a double bearing having a radial bearing (RB) and a thrust bearing (TB) each formed in two regions, having improved dynamic characteristics by forming a lower thrust bearing so as to have dynamic pressure rigidity larger than that of an upper thrust bearing, such that performance of a motor may be improved, and a spindle motor having the same.

According to a preferred embodiment of the present invention, there is provided a hydrodynamic bearing module including: a shaft having a flange part formed at a lower portion thereof; a sleeve rotatably supporting the shaft; a cover coupled to a lower end portion of the sleeve and supporting the shaft; a radial bearing formed between the shaft and the sleeve in a radial direction of the shaft; and an upper thrust bearing formed between the flange part and the sleeve and a lower thrust bearing formed between the flange part and the cover, in an axial direction of the shaft.

The sleeve may include upper and lower radial dynamic pressure generation grooves formed in an inner peripheral surface thereof facing the shaft.

The sleeve may include an upper thrust dynamic pressure generation groove formed in one surface thereof facing the flange part, and the cover may include a lower thrust dynamic pressure generation groove formed in one surface thereof facing the flange part.

The lower thrust dynamic pressure generation groove may have a formation area larger than that of the upper thrust dynamic pressure generation groove.

A ratio of the formation area of the lower thrust dynamic pressure generation groove to the formation area of the upper thrust dynamic pressure generation groove may be 1.2:1 to 1.5:1.

The shaft may include upper and lower radial dynamic pressure generation grooves formed in an outer peripheral surface thereof facing the sleeve.

The flange part of the shaft may include upper and lower thrust dynamic pressure generation grooves formed in one surface thereof facing the sleeve.

The lower thrust dynamic pressure generation groove may have a formation area larger than that of the upper thrust dynamic pressure generation groove.

A ratio of the formation area of the lower thrust dynamic pressure generation groove to the formation area of the upper thrust dynamic pressure generation groove may be 1.2:1 to 1.5:1.

According to another preferred embodiment of the present invention, there is provided a spindle motor including: a rotor including a shaft having a flange part formed at a lower portion thereof; a hub, and a magnet; a stator including a sleeve rotatably supporting the shaft, a base having the sleeve coupled thereto, an armature facing the magnet, fixedly coupled to the base, including a core and a coil, a pulling plate facing the magnet in an axial direction of the shaft, and a cover supporting the shaft and coupled to the sleeve; and a hydrodynamic bearing formed between the rotor and the stator by injection of oil, wherein the hydrodynamic bearing includes: a radial bearing formed between the shaft and the sleeve in a radial direction of the shaft; and an upper thrust bearing formed between the flange part and the sleeve and a lower thrust bearing formed between the flange part and the cover, in an axial direction of the shaft.

The sleeve may include upper and lower radial dynamic pressure generation grooves formed in an inner peripheral surface thereof facing the shaft.

The sleeve may include an upper thrust dynamic pressure generation groove formed in one surface thereof facing the flange part, and the cover may include a lower thrust dynamic pressure generation groove formed in one surface thereof facing the flange part.

The lower thrust dynamic pressure generation groove may have a formation area larger than that of the upper thrust dynamic pressure generation groove.

A ratio of the formation area of the lower thrust dynamic pressure generation groove to the formation area of the upper thrust dynamic pressure generation groove may be 1.2:1 to 1.5:1.

The shaft may include upper and lower radial dynamic pressure generation grooves formed in an outer peripheral surface thereof facing the sleeve.

The flange part of the shaft may include upper and lower thrust dynamic pressure generation grooves formed in one surface thereof facing the sleeve.

The lower thrust dynamic pressure generation groove may have a formation area larger than that of the upper thrust dynamic pressure generation groove.

A ratio of the formation area of the lower thrust dynamic pressure generation groove to the formation area of the upper thrust dynamic pressure generation groove may be 1.2:1 to 1.5:1.

### BRIEF DESCRIPTION OF THE DRAWINGS

FIG. 1 is a cross-sectional view schematically showing a hydrodynamic bearing module according to a first preferred embodiment of the present invention;

FIG. 2 is a cross-sectional view schematically showing a spindle motor including the hydrodynamic bearing module according to the first preferred embodiment of the present invention shown in FIG. 1;

FIG. 3 is a cross-sectional view schematically showing a hydrodynamic bearing module according to a second preferred embodiment of the present invention; and

FIG. 4 is a cross-sectional view schematically showing a spindle motor including the hydrodynamic bearing module according to the second preferred embodiment of the present invention shown in FIG. 3.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, a hydrodynamic module and a spindle motor having the same according to preferred embodiments of the present invention will be described in detail with reference to the accompanying drawings.

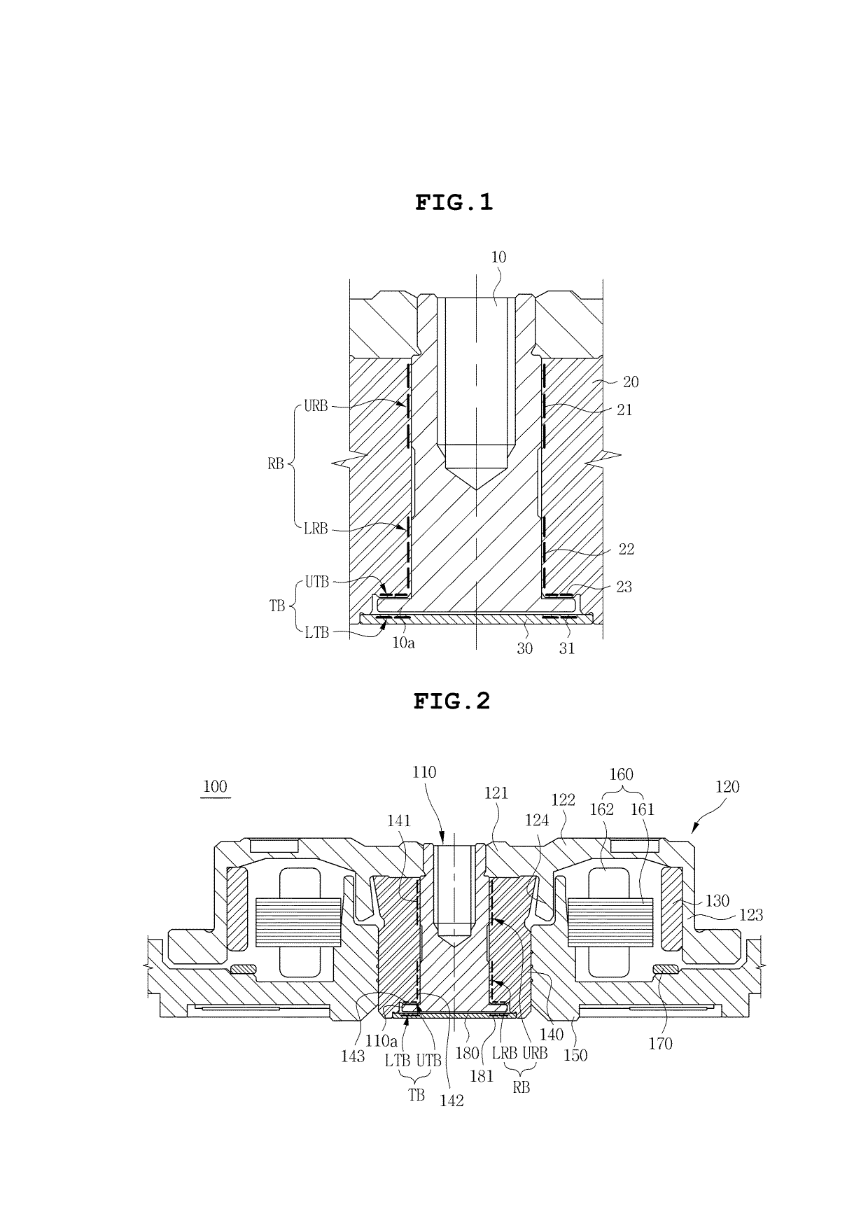

FIG. 1 is a cross-sectional view schematically showing a hydrodynamic bearing module according to a first preferred embodiment of the present invention. As shown, the hydrodynamic bearing module includes a shaft 10, a sleeve 20, and a cover 30, and has a double bearing structure in which each of a radial bearing RB and a thrust bearing TB is formed in two regions.

More specifically, the shaft 10 includes a flange part 10a formed at a lower portion thereof. In addition, the shaft 10 and the sleeve 20 include a micro clearance formed therebetween in a radial direction of the shaft. Oil is injected into the micro clearance, such that the radial bearing RB, which is a hydrodynamic bearing, is formed.

Further, the radial bearing RB includes an upper radial bearing URB formed at an upper portion and a lower radial bearing LRB formed at a lower portion.

In addition, the thrust bearing TB is formed in a micro clearance between the flange part 10a and the sleeve and in a micro clearance between the flange part 10a and the cover 30 in an axial direction of the shaft.

Further, the thrust bearing TB includes an upper thrust bearing UTB formed between the flange part 10a and the sleeve and a lower thrust bearing LTB formed between the flange part 10a and the cover 30.

In addition, the sleeve 20 rotatably supports the shaft 10, and includes an upper radial dynamic pressure generation groove 21 formed in an inner peripheral surface thereof facing the shaft 10 in order to form the upper radial bearing URB and a lower radial dynamic pressure generation groove 22 formed in the inner peripheral surface thereof facing the shaft 10 in order to form the lower radial bearing LRB.

Further, the sleeve 20 includes an upper thrust dynamic pressure generation groove 23 formed in one surface thereof facing the flange part 10a in order to form the upper thrust bearing UTB. In addition, the upper thrust dynamic pressure generation groove 23 may have a herringbone shape or a spiral shape.

In addition, the cover 30, which is to support a lower portion of the shaft 10 and seal the oil injected in order to form the hydrodynamic bearing, is mounted on an inner peripheral surface of a lower end portion of the sleeve 20. Further, the cover 30 include a lower thrust dynamic pressure generation groove 31 formed in one surface thereof facing the flange part in order to form the lower thrust bearing LTB. The lower thrust dynamic pressure generation groove 31 may have a herringbone shape or a spiral shape.

In a dynamic pressure design of the hydrodynamic bearing module according to the first preferred embodiment of the present invention configured as described above, the radial bearing RB may be designed to be down-pumped, and the upper thrust bearing may be designed to have dynamic pressure rigidity smaller than that of the lower thrust bearing.

To this end, the lower thrust dynamic pressure generation groove has a formation area larger than that of the upper thrust dynamic pressure generation groove. That is, a ratio of the formation area of the lower thrust dynamic pressure generation groove to the formation area of the upper thrust dynamic pressure generation groove may be 1.2:1 to 1.5:1.

In the above-mentioned configuration, excessive floating of a rotor of a spindle motor is controlled by attractive force between a magnet and a pulling plate to be described below.

FIG. 2 is a cross-sectional view schematically showing a spindle motor including the hydrodynamic bearing module according to the first preferred embodiment of the present invention shown in FIG. 1. As shown, the spindle motor 100 is configured to include a rotor including a shaft 110, a hub 120, and a magnet 130; a stator including a sleeve 140, a base 150, an armature 160, a pulling plate 170, and a cover 180; and a hydrodynamic bearing formed between the rotor and the stator by injection of oil, which is an operating fluid.

In the rotor, the shaft 110 includes the hub 120 coupled to an upper end portion thereof and a flange part 110a formed at a lower end portion thereof.

In addition, the hub 120 includes a cylindrical part 121 fixed to the upper end portion of the shaft 110, a disk part 122 extended from the cylindrical part 121 in an outer diameter direction, a sidewall part 123 extended downwardly from an end portion of the disk part 122 in the outer diameter direction in an axial direction of the shaft, and a sealing part 124 extended downwardly in the axial direction of the shaft and facing an outer peripheral portion of the sleeve.

In addition, the sidewall part 123 includes an annular ring shaped magnet 130 mounted on an inner peripheral surface thereof so as to face the armature 160 including a core 161 and a coil 162.

Next, in the stator part, the sleeve 140 rotatably supports the shaft 110 and is fixed to the base 150. In addition, the sleeve 140 may have an oil circulation hole (not shown) formed therein in the axial direction of the shaft 110 so that upper and lower surfaces of the sleeve 140 are connected to each other in order to circulate the oil in a shaft system.

In addition, a radial bearing RB, which is a hydrodynamic bearing, is formed between the sleeve 140 and the shaft 110. More specifically, the radial bearing RB is formed by forming a micro clearance between the shaft 110 and the sleeve 140 and injecting the oil into the micro clearance.

More specifically, the radial bearing RB includes an upper radial bearing URB and a lower radial bearing LRB, and each of upper and lower radial dynamic pressure generation groove 141 and 142 is formed in an inner peripheral surface of the sleeve 140 facing the shaft in order to form the upper radial bearing URB and the lower radial bearing LRB.

Further, the sleeve 140 includes an upper thrust dynamic pressure generation groove 143 formed in one surface thereof facing the flange part 110a in order to form an upper thrust bearing UTB in a micro clearance between the sleeve 140 and the flange part 110a.

Further, the base 150 includes the armature 170 fixed to an outer peripheral portion thereof by press-fitting, adhesion, or the like, so as to face the magnet 130 and includes the sleeve 140 fixed to an inner peripheral portion thereof by press-fitting, adhesion, or the like, wherein the armature 170 includes the core 161 and the coil 162.

Further, the pulling plate 170, which is to prevent floating of the rotor by attractive force of the magnet 130, is mounted on the base 150 so as to face the magnet 130 in the axial direction of the shaft.

In addition, the cover 180, which is to support a lower portion of the shaft 110 and seal the oil injected in order to form the hydrodynamic bearing, is mounted on an inner peripheral surface of a lower end portion of the sleeve 140. Further, the cover 140 include a lower thrust dynamic pressure generation groove 181 formed in one surface thereof facing the flange part 110a in order to form a lower thrust bearing LTB.

The upper and lower thrust dynamic pressure generation grooves 143 and 181 may have a herringbone shape or a spiral shape.

In a dynamic pressure design of the spindle motor including the hydrodynamic bearing module according to the first preferred embodiment of the present invention configured as described above, the radial bearing RB may be designed to be down-pumped, and the upper thrust bearing may be designed to have dynamic pressure rigidity smaller than that of the lower thrust bearing. In the above-mentioned configuration, excessive floating of a rotor of the spindle motor is controlled by attractive force between the magnet 130 and the pulling plate 170.

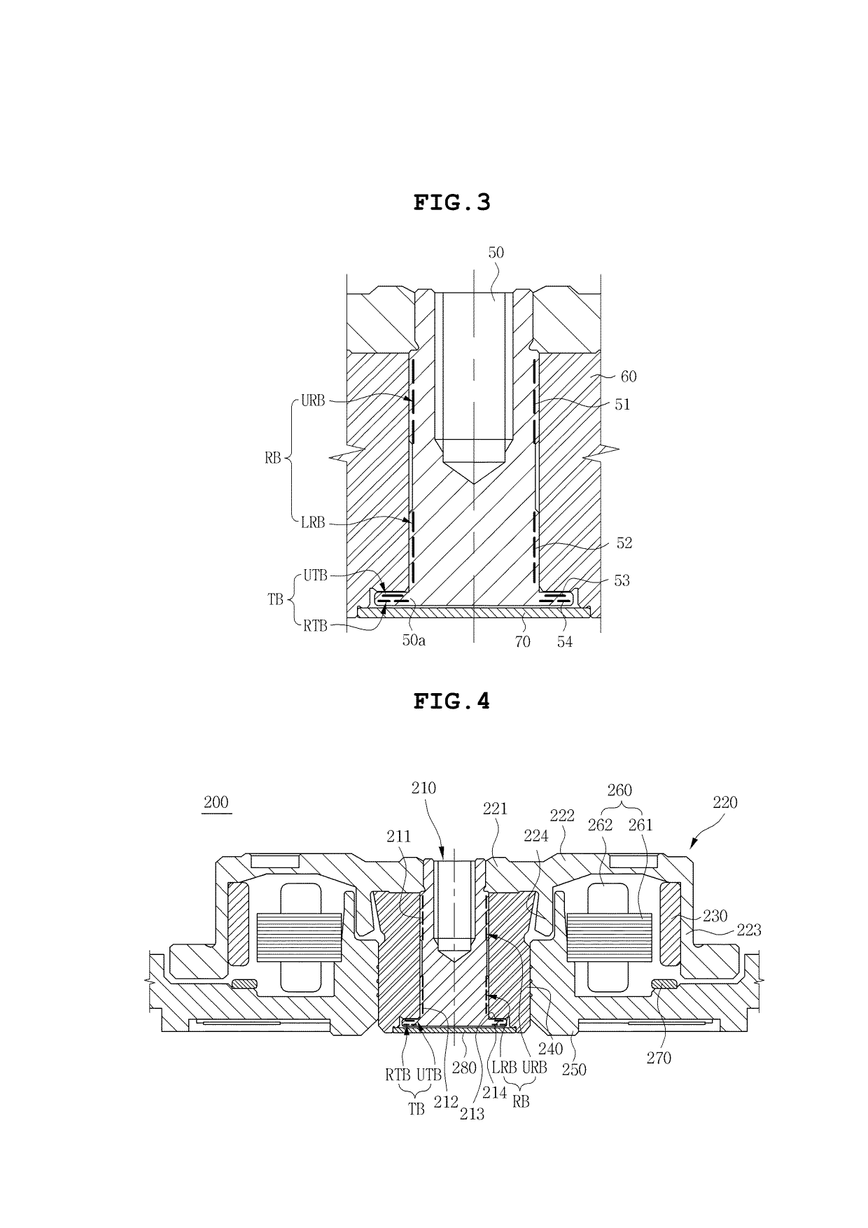

FIG. 3 is a cross-sectional view schematically showing a hydrodynamic bearing module according to a second preferred embodiment of the present invention. As shown, the hydrodynamic bearing module includes a shaft 50, a sleeve 60, and a cover 70, and has a double bearing structure in which each of a radial bearing RB and a thrust bearing TB is formed in two regions.

More specifically, the shaft 50 includes a flange part 50a formed at a lower portion thereof. In addition, the shaft 50 and the sleeve 60 include a micro clearance formed therebetween in a radial direction of the shaft. Oil is injected into the micro clearance, such that the radial bearing RB, which is a hydrodynamic bearing, is formed.

Further, the radial bearing RB includes an upper radial bearing URB formed at an upper portion and a lower radial bearing LRB formed at a lower portion.

In addition, the thrust bearing TB is formed in a micro clearance between the flange part 50a and the sleeve 60 and in a micro clearance between the flange part 50a and the cover 70 in an axial direction of the shaft.

Further, the thrust bearing TB includes an upper thrust bearing UTB formed between the flange part 50a and the sleeve and a lower thrust bearing LTB formed between the flange part 50a and the cover 70.

In addition, the shaft 50 includes an upper radial dynamic pressure generation groove 51 formed in an outer peripheral surface thereof facing the sleeve in order to form the upper radial bearing URB and a lower radial dynamic pressure generation groove 52 formed in the outer peripheral surface thereof facing the sleeve in order to form the lower radial bearing LRB.

In addition, the flange 50a includes an upper thrust dynamic pressure generation groove 53 formed in one surface thereof facing the sleeve in order to form the upper thrust bearing UTB and includes a lower thrust dynamic pressure generation groove 54 formed in one surface thereof facing the cover 70 in order to form the lower thrust bearing LTB.

The upper and lower thrust dynamic pressure generation grooves 53 and 54 may have a herringbone shape or a spiral shape.

In addition, the sleeve 60 rotatably supports the shaft 50.

Further, the cover 70, which is to support a lower portion of the shaft 50 and seal the oil injected in order to form the hydrodynamic bearing, is mounted on an inner peripheral surface of a lower end portion of the sleeve 60.

In a dynamic pressure design of the hydrodynamic bearing module according to the second preferred embodiment of the present invention configured as described above, the radial bearing RB may be designed to be down-pumped, and the upper thrust bearing may be designed to have dynamic pressure rigidity smaller than that of the lower thrust bearing.

To this end, the lower thrust dynamic pressure generation groove has a formation area larger than that of the upper thrust dynamic pressure generation groove. In addition, a ratio of the formation area of the lower thrust dynamic pressure generation groove to the formation area of the upper thrust dynamic pressure generation groove may be 1.2:1 to 1.5:1.

In the above-mentioned configuration, excessive floating of a rotor of a spindle motor is controlled by attractive force between a magnet and a pulling plate to be described below.

FIG. 4 is a cross-sectional view schematically showing a spindle motor including the hydrodynamic bearing module according to the second preferred embodiment of the present invention shown in FIG. 3. As shown, the spindle motor 200 is configured to include a rotor including a shaft 210, a hub 220, and a magnet 230; a stator including a sleeve 240, a base 250, an armature 260, a pulling plate 270, and a cover 280; and a hydrodynamic bearing formed between the rotor and the stator by injection of oil, which is an operating fluid.

In the rotor, the shaft 210 includes the hub 220 coupled to an upper end portion thereof and a flange part 210a formed at a lower end portion thereof.

In addition, the shaft 210 and the sleeve 240 include a micro clearance formed therebetween in a radial direction of the shaft. Oil is injected into the micro clearance, such that the radial bearing RB, which is a hydrodynamic bearing, is formed.

Further, the radial bearing RB includes an upper radial bearing URB formed at an upper portion and a lower radial bearing LRB formed at a lower portion.

In addition, a thrust bearing TB is formed in a micro clearance between the flange part 210a and the sleeve 240 and in a micro clearance between the flange part 210a and the cover 280 in an axial direction of the shaft 210.

Further, the thrust bearing TB includes an upper thrust bearing UTB formed between the flange part 210a and the sleeve 240 and a lower thrust bearing LTB formed between the flange part 210a and the cover 280.

In addition, the shaft 210 includes an upper radial dynamic pressure generation groove 211 formed in an outer peripheral surface thereof facing the sleeve in order to form the upper radial bearing URB and a lower radial dynamic pressure generation groove 212 formed in the outer peripheral surface thereof facing the sleeve in order to form the lower radial bearing LRB.

In addition, the flange 210a includes an upper thrust dynamic pressure generation groove 213 formed in one surface thereof facing the sleeve 240 in order to form the upper thrust bearing UTB and includes a lower thrust dynamic pressure generation groove 214 formed in one surface thereof facing the cover 280 in order to form the lower thrust bearing LTB.

The upper and lower thrust dynamic pressure generation grooves 213 and 214 may have a herringbone shape or a spiral shape.

In addition, the hub 220 includes a cylindrical part 221 fixed to the upper end portion of the shaft 210, a disk part 222 extended from the cylindrical part 221 in an outer diameter direction, a sidewall part 223 extended downwardly from an end portion of the disk part 222 in the outer diameter direction in an axial direction of the shaft, and a sealing part 224 extended downwardly in the axial direction of the shaft and facing an outer peripheral portion of the sleeve.

In addition, the sidewall part 223 includes an annular ring shaped magnet 230 mounted on an inner peripheral surface thereof so as to face the armature 260 including the core 261 and the coil 262.

Next, in the stator part, the sleeve 240 rotatably supports the shaft 110 and is fixed to the base 250. In addition, the sleeve 240 may have an oil circulation hole (not shown) formed therein in the axial direction of the shaft 210 so that upper and lower surfaces of the sleeve 240 are connected to each other in order to circulate the oil in a shaft system.

Further, the base 250 includes the armature 270 fixed to an outer peripheral portion thereof by press-fitting, adhesion, or the like, so as to face the magnet 230 and includes the sleeve 240 fixed to an inner peripheral portion thereof by press-fitting, adhesion, or the like, wherein the armature 270 includes the core 261 and the coil 262.

Further, the pulling plate 270, which is to prevent floating of the rotor by attractive force of the magnet 230, is mounted on the base 250 so as to face the magnet 230 in the axial direction of the shaft.

In addition, the cover 280 is to support a lower portion of the shaft 210 and seal the oil injected in order to form the hydrodynamic bearing. As described above, the oil is injected into the micro clearance between the shaft 210 and the flange part 210a, such that the lower thrust bearing LTB is formed.

In a dynamic pressure design of the spindle motor including the hydrodynamic bearing module according to the second preferred embodiment of the present invention configured as described above, the radial bearing RB may be designed to be down-pumped, and the upper thrust bearing may be designed to have dynamic pressure rigidity smaller than that of the lower thrust bearing. In the above-mentioned configuration, excessive floating of a rotor of the spindle motor is controlled by attractive force between the magnet 230 and the pulling plate 270.

As set forth above, according to the preferred embodiment of the present invention, it is possible to obtain a hydrodynamic bearing module including a double bearing having a radial bearing (RB) and a thrust bearing (TB) each formed in two regions, having improved dynamic characteristics by forming a lower thrust bearing so as to have dynamic pressure rigidity larger than that of an upper thrust bearing, such that performance of a motor may be improved, and a spindle motor having the same.

Although the preferred embodiments of the present invention have been disclosed for illustrative purposes, they are for specifically explaining the present invention and thus a hydrodynamic bearing module and a spindle motor having the same according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A hydrodynamic bearing module comprising:
a shaft having a flange part formed at a lower portion thereof,
a sleeve rotatably supporting the shaft;
a cover coupled to a lower end portion of the sleeve and supporting the shaft;
a radial bearing formed between the shaft and the sleeve in a radial direction of the shaft; and
an upper thrust bearing formed between the flange part and the sleeve and a lower thrust bearing formed between the flange part and the cover, in an axial direction of the shaft.

2. The hydrodynamic bearing module as set forth in claim 1, wherein the sleeve includes upper and lower radial dynamic pressure generation grooves formed in an inner peripheral surface thereof facing the shaft.

3. The hydrodynamic bearing module as set forth in claim 1, wherein the sleeve includes an upper thrust dynamic pressure generation groove formed in one surface thereof facing the flange part, and the cover includes a lower thrust dynamic pressure generation groove formed in one surface thereof facing the flange part.

4. The hydrodynamic bearing module as set forth in claim 3, wherein the lower thrust dynamic pressure generation groove has a formation area larger than that of the upper thrust dynamic pressure generation groove.

5. The hydrodynamic bearing module as set forth in claim 4, wherein a ratio of the formation area of the lower thrust dynamic pressure generation groove to the formation area of the upper thrust dynamic pressure generation groove is 1.2:1 to 1.5:1.

6. The hydrodynamic bearing module as set forth in claim 1, wherein the shaft includes upper and lower radial dynamic pressure generation grooves formed in an outer peripheral surface thereof facing the sleeve.

7. The hydrodynamic bearing module as set forth in claim 1, wherein the flange part of the shaft includes upper and lower thrust dynamic pressure generation grooves formed in one surface thereof facing the sleeve.

8. The hydrodynamic bearing module as set forth in claim 7, wherein the lower thrust dynamic pressure generation groove has a formation area larger than that of the upper thrust dynamic pressure generation groove.

9. The hydrodynamic bearing module as set forth in claim 8, wherein a ratio of the formation area of the lower thrust dynamic pressure generation groove to the formation area of the upper thrust dynamic pressure generation groove is 1.2:1 to 1.5:1.

10. A spindle motor comprising:
a rotor including a shaft having a flange part formed at a lower end portion thereof, a hub, and a magnet;
a stator including a sleeve rotatably supporting the shaft, a base having the sleeve coupled thereto, an armature facing the magnet, fixedly coupled to the base, including a core and a coil, a pulling plate facing the magnet in an axial direction of the shaft, and a cover supporting the shaft and coupled to the sleeve; and
a hydrodynamic bearing formed between the rotor and the stator by injection of oil,
wherein the hydrodynamic bearing includes:
a radial bearing formed between the shaft and the sleeve in a radial direction of the shaft; and
an upper thrust bearing formed between the flange part and the sleeve and a lower thrust bearing formed between the flange part and the cover, in an axial direction of the shaft.

11. The spindle motor as set forth in claim 10, wherein the sleeve includes upper and lower radial dynamic pressure generation grooves formed in an inner peripheral surface thereof facing the shaft.

12. The spindle motor as set forth in claim 10, wherein the sleeve includes an upper thrust dynamic pressure generation groove formed in one surface thereof facing the flange part, and the cover includes a lower thrust dynamic pressure generation groove formed in one surface thereof facing the flange part.

13. The spindle motor as set forth in claim 12, wherein the lower thrust dynamic pressure generation groove has a formation area larger than that of the upper thrust dynamic pressure generation groove.

14. The spindle motor as set forth in claim 13, wherein a ratio of the formation area of the lower thrust dynamic pressure generation groove to the formation area of the upper thrust dynamic pressure generation groove is 1.2:1 to 1.5:1.

15. The spindle motor as set forth in claim 10, wherein the shaft includes upper and lower radial dynamic pressure generation grooves formed in an outer peripheral surface thereof facing the sleeve.

16. The spindle motor as set forth in claim 10, wherein the flange part of the shaft includes upper and lower thrust dynamic pressure generation grooves formed in one surface thereof facing the sleeve.

17. The spindle motor as set forth in claim 16, wherein the lower thrust dynamic pressure generation groove has a formation area larger than that of the upper thrust dynamic pressure generation groove.

18. The spindle motor as set forth in claim 17, wherein ratio of the formation area of the lower thrust dynamic pressure generation groove to the formation area of the upper thrust dynamic pressure generation groove is 1.2:1 to 1.5:1.
